(19) United States
(12) Patent Application Publication
(10) Pub. No.: US 2026/0087882 A1
(43) Pub. Date: Mar. 26, 2026

(54) GAMING MACHINE, METHOD FOR PROVIDING GAME, AND STORAGE MEDIUM

(71) Applicant: Konami Gaming, Inc., Las Vegas, NV (US)

(72) Inventor: Kazutaka SHIRAISHI, Kanagawa (JP)

(21) Appl. No.: 19/336,261

(22) Filed: Sep. 22, 2025

(30) Foreign Application Priority Data
Sep. 26, 2024 (JP) 2024-167616

(51) Int. Cl. G07F 17/32

(52) U.S. Cl. CPC G07F 17/3244; G07F 17/3213

(57) ABSTRACT

A gaming machine includes a display unit having a display region provided with a win line, and a control unit. The control unit is configured to: spin and stop a plurality of reels to display symbols in the display region; determine a reel to be respun if the symbols in the display region satisfy a predetermined condition when the plurality of reels stop; when a special symbol is stopped in the display region by the reel to be respun, miniaturize the special symbol and hold it in the cell where the special symbol has stopped, to allow another symbol to be stopped in the cell; respin and stop the reel to be respun; determine an award based on an award amount associated with the special symbols and the miniaturized special symbols displayed on the win line; and provide the determined award to a player.

### CROSS-REFERENCE TO RELATED APPLICATION

This application claims the benefit of priority from Japanese Patent Application No. 2024-167616, filed on Sep. 26, 2024, the entire contents of which are incorporated herein by reference.

### TECHNICAL FIELD

The present disclosure relates to a gaming machine, a gaming method, and a storage medium.

### BACKGROUND

U.S. Pat. No. 5,833,537 discloses a gaming machine that provides a slot game. This gaming machine provides a persistent symbol that is persistently displayed on the screen from one round to subsequent rounds in response to conditions such as a game event. The persistent symbol, for example, maintains its position and effect through two or more consecutive rounds of the game. For example, the persistent symbol doubles the award upon winning on a payline where it is placed.

### SUMMARY

In the gaming machine described in U.S. Pat. No. 5,833,537, the feature that when a persistent symbol appears, its effect is sustained in subsequent rounds is easy for players to understand and has been applied to various games. However, even if a persistent symbol appears, it may not be sustained in subsequent rounds if conditions are not met, and it is not uncommon for the appearance of a persistent symbol to fail to meet the player's expectations. In view of such related art, an object of the present disclosure is to provide a game that has new gameplay and/or a game mechanics to attract the player's interest and is capable of offering a progression that sufficiently provides new stimulation and excitement to the player. Note that “gameplay” as used in this specification is a general term for rules for game progression, a mechanism for generating a win, a system for determining an award amount, and the like. Furthermore, the term “game mechanics” as used in this specification refers to the rules, mechanisms, algorithms, systems, etc. that provide the gameplay to players.

A gaming machine according to one aspect of the present disclosure includes: a display unit having a display region for displaying a symbol in each of cells arranged in a matrix, the display region being provided with a win line composed of a plurality of cells, and symbols including a special symbol associated with a predetermined award amount; and a control unit connected to the display unit, wherein the control unit is configured to: spin and stop a plurality of reels to cause the symbols to be displayed in the display region; determine a reel to be respun if the symbols in the display region satisfy a predetermined condition after the plurality of reels stop; when the special symbol is stopped in the display region by the reel to be respun, miniaturize the special symbol and hold the miniaturized special symbol in a cell where the special symbol has stopped, to allow another symbol to be stopped in the cell; respin and stop the reel to be respun; determine an award based on an award amount associated with the special symbols and the miniaturized special symbols displayed on the win line; and provide the determined award to a player.

In this gaming machine, a plurality of reels are spun and stopped to display symbols in the cells of the display region. If the symbols in the display region satisfy a predetermined condition when the plurality of reels stop, a reel to be respun is determined. At this time, if a special symbol is stopped in the display region by the reel to be respun, the special symbol is miniaturized and held in the cell. This allows another symbol to be stopped in the cell where the special symbol has stopped. Then, the reel to be respun is respun and stopped. Since another symbol stops in the cell where the special symbol is held, two symbols, the special symbol and the other symbol, will be stopped in one cell. Then, an award is determined based on the symbols on the win line and the award amount associated with the miniaturized special symbol on the win line, and the determined award is provided to the player. In this way, this gaming machine can determine the award also using the award amount associated with the special symbol that is miniaturized and held on the win line of the reel to be respun. Therefore, it is possible to prevent a once-displayed special symbol from being moved by a respin and excluded from the award, thereby suppressing a situation that fails to meet the player's expectations, and allowing the player to expect a new win that occurs when another symbol stops while maintaining the special symbol. Therefore, this gaming machine can provide a game that has new gameplay to attract the player's interest and is capable of offering a progression that sufficiently provides new stimulation and excitement to the player. In other words, this gaming machine implements game mechanics that enable such gameplay.

In one embodiment, the control unit may determine the reel to be respun in response to the special symbols forming a series of adjacent symbols on the win line when the plurality of reels have stopped. In such a gaming machine, for example, a win is determined when a series of adjacent symbols composed of a predetermined number of special symbols is formed, and an opportunity to win or an opportunity to increase the award at the time of winning can be provided by a respin.

In one embodiment, the control unit may provide to the player a sum of the award amount associated with the special symbols that formed the series of adjacent symbols on the win line, and the award amount of the miniaturized special symbol that appeared in the same cell as the special symbol. Such a gaming machine can provide a game in which a win is determined when a series of adjacent symbols is formed on the win line. Then, since not only the award amount associated with the special symbols that formed the series of adjacent symbols but also the award amount of the miniaturized special symbol is provided to the player, the award amount that can be obtained at one time can be increased.

In one embodiment, the control unit may hold reels that form the series of adjacent symbols, and respin unheld reels. Such a gaming machine can hold reels that contribute to a win or reels that already constitute a win, thereby avoiding giving a disadvantage to the player by a respin.

In one embodiment, the control unit may, when a respun reel stops, if a new special symbol connects to the series of adjacent symbols, further hold a reel corresponding to the new special symbol and respin the unheld reels. Then, when a respun reel stops, if a new special symbol does not connect to the series of adjacent symbols, the next respin need not be executed. Such a gaming machine can provide a game that performs a further respin when a new special symbol connects to the series of adjacent symbols in the respin, and ends the respin when a new special symbol does not connect to the series of adjacent symbols in the respin. In addition, by repeating the respin, two or more symbols can be stopped in one cell, and two or more symbols can be used for the award.

In one embodiment, the control unit may, when performing a respin, display a frame enclosing a first display region corresponding to held reels and a second display region corresponding to an adjacent reel adjacent to the held reels, and when a new special symbol is stopped by the adjacent reel, expand the frame to include a third display region corresponding to a reel further adjacent to the adjacent reel that stopped the new special symbol, and provide to the player a total of the award amounts associated with the special symbols and the miniaturized special symbols stopped within a range enclosed by the frame when the respin ends. Such a gaming machine can distinguish and display the special symbols that are eligible for a win among the displayed special symbols using the frame. Therefore, the player can play the game without being conscious of the win line.

A game providing method according to another aspect of the present disclosure is a game providing method executed in a gaming machine comprising a display unit having a display region for displaying a symbol in each of cells arranged in a matrix, the display region being provided with a win line composed of a plurality of cells, and symbols including a special symbol associated with a predetermined award amount, and a control unit connected to the display unit, the method comprising: spinning and stopping a plurality of reels to cause the symbols to be displayed in the display region; determining a reel to be respun if the symbols in the display region satisfy a predetermined condition after the plurality of reels stop; when the special symbol is stopped in the display region by the reel to be respun, miniaturizing the special symbol and holding the miniaturized special symbol in a cell where the special symbol has stopped, to allow another symbol to be stopped in the cell; respinning and stopping the reel to be respun; determining an award based on an award amount associated with the special symbols and the miniaturized special symbols displayed on the win line; and providing the determined award to a player. This game providing method achieves the same effects as the above-described gaming machine.

A computer-readable storage medium according to another aspect of the present disclosure stores a program executed by a control unit in a gaming machine comprising a display unit having a display region for displaying a symbol in each of cells arranged in a matrix, the display region being provided with a win line composed of a plurality of cells, and symbols including a special symbol associated with a predetermined award amount, and a control unit connected to the display unit, the program causing the control unit to: spin and stop a plurality of reels to cause the symbols to be displayed in the display region; determine a reel to be respun if the symbols in the display region satisfy a predetermined condition after the plurality of reels stop; when the special symbol is stopped in the display region by the reel to be respun, miniaturize the special symbol and hold the miniaturized special symbol in a cell where the special symbol has stopped, to allow another symbol to be stopped in the cell; respin and stop the reel to be respun; determine an award based on an award amount associated with the special symbols and the miniaturized special symbols displayed on the win line; and provide the determined award to a player. This program achieves the same effects as the above-described gaming machine.

According to the present disclosure, there are provided a gaming machine, a game providing method, and a program capable of providing a game that has new gameplay to attract the player's interest and is capable of offering a progression that sufficiently provides new stimulation and excitement to the player. In other words, those gaming machine, game providing method and program implements game mechanics that enable such gameplay. Note that the present disclosure is directed to a technical improvement for computer-implemented gaming machines. Specifically, it addresses the technical problem of how to present complex game state transitions and outcomes to a player in a clear and intuitive manner on a graphical user interface (GUI). The disclosed solution, involving a specific, ordered combination of steps performed by a processor, such as rendering, animating, and modifying graphical elements, improves the functioning of the computer itself by enhancing the human-machine interface and providing dynamic visual feedback that cannot be replicated by mental steps or with pen and paper.

### BRIEF DESCRIPTION OF THE DRAWINGS

FIG. 1 is a perspective view illustrating an example of a gaming machine according to an embodiment.

FIG. 2 is a block diagram showing an example of the configuration of the gaming machine shown in FIG. 1.

FIG. 3 is a schematic diagram of a display region of the gaming machine of FIG. 1.

FIG. 4 is a diagram illustrating an example of a virtual reel strip.

FIG. 5 is a diagram illustrating an example of symbols.

FIGS. 6A, 6B, and 6C are diagrams illustrating a state of symbol arrangement in a game.

FIGS. 7A, 7B, and 7C are diagrams illustrating a state of symbol arrangement in a game.

FIGS. 8A, 8B, and 8C are diagrams illustrating a state of symbol arrangement in a game.

FIG. 9 is a directory configuration diagram and a block diagram showing programs and data stored in the memory shown in FIG. 2.

FIG. 10 is a block diagram of a system for a gaming machine.

FIG. 11 is a block diagram of the game application program of FIG. 10.

FIG. 12 is a block diagram of the system application program shown in FIG. 10.

FIG. 13 is a flowchart for explaining the operation of the gaming machine.

### DETAILED DESCRIPTION

Hereinafter, a gaming machine according to an embodiment will be described with reference to the accompanying drawings. In the drawings, the same or corresponding parts are denoted by the same reference numerals, and redundant description is omitted.

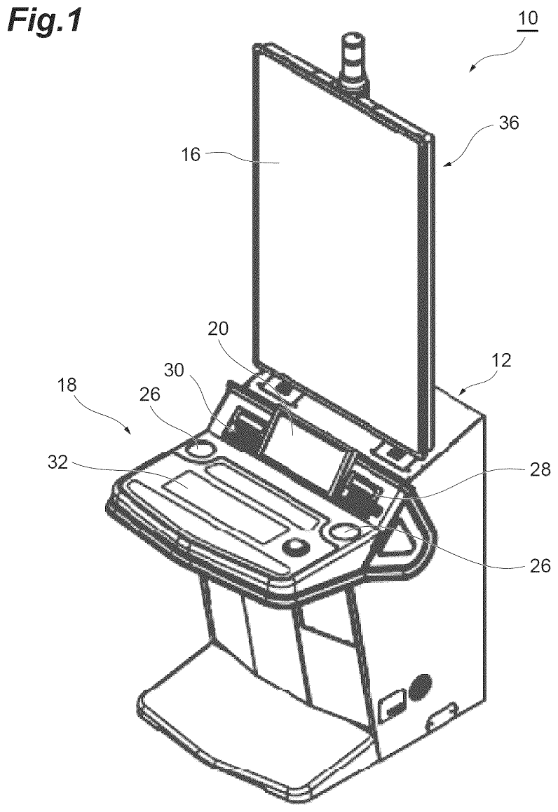

FIG. 1 is a perspective view illustrating an example of a gaming machine according to an embodiment. Here, the gaming machine is a device that receives a wager such as cash, medals, or tokens from a player, starts a game, and pays a prize, an award, or a payout to the player according to a randomly determined game result. Such a gaming machine is designed and manufactured in accordance with local regulations, and is installed as a device in a licensed facility such as a casino after obtaining authorization by an authorization agency. The gaming machine 10 shown in FIG. 1 may receive a predetermined game value from the player, generate a game result, and provide a payout to the player in response to the game result and a pay table. The gaming machine 10 provides a video slot game as an example. The video slot game includes, for example, a normal game, a free game, and a feature game. The normal game, free game, and feature game are provided when a predetermined condition is satisfied. In the normal game, free game, and feature game, symbols displayed in the display region constitute a game result (such as a combination of symbols), and a winning is determined.

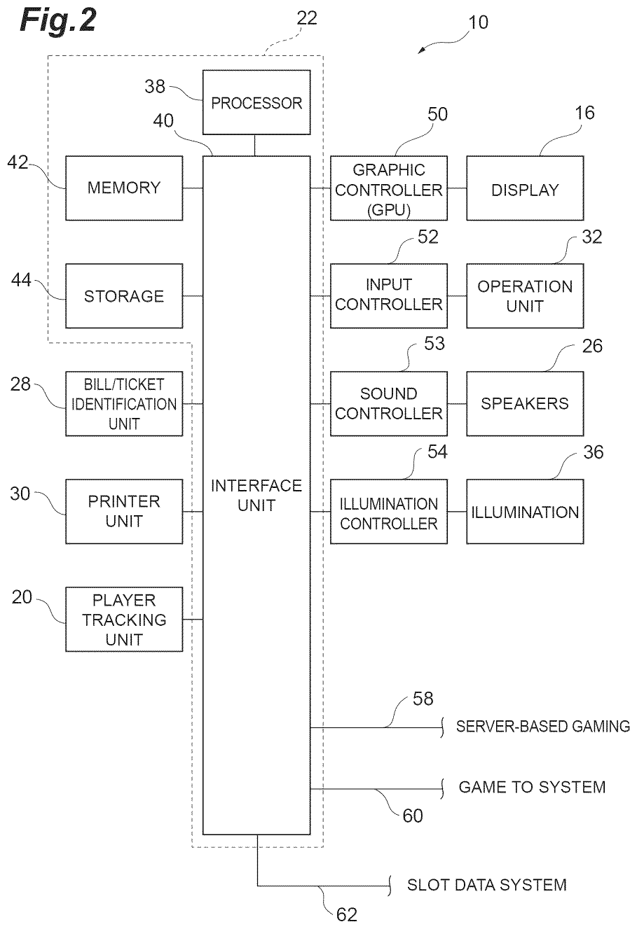

As shown in FIG. 1, the gaming machine 10 includes a display 16 (an example of a display unit) and a cabinet 12. The cabinet 12 also houses a control unit 22 (see FIG. 2) for controlling the components of the gaming machine 10.

The display 16 is a flat panel display device such as a liquid crystal display device or an organic EL display device. The display 16 is controlled via the control unit 22 to provide a game screen to the player. An illumination 36 may be provided around the display 16 to provide decorative lighting.

The cabinet 12 is disposed below the display 16. A control panel 18 is provided on the front surface of the cabinet 12 so as to project forward. The control panel 18 is provided with a player tracking unit 20, speakers 26, a bill/ticket identification unit 28, a printer unit 30, and an operation unit 32.

The player tracking unit 20 includes a card reader for recognizing a player identification card, a display for presenting data to the player, and a keypad for receiving input by the player. The player tracking unit 20 cooperates with the control unit 22 or an external system to read information recorded on the player identification card inserted into the card reader by the player and display the information and/or information acquired by communicating with the external system on a display. Furthermore, input from the player is received by the keypad, the display is changed according to the input, and communication with an external system is performed as necessary.

The speakers 26 are provided on the left and right of the control panel 18. The speakers 26 are controlled via the control unit 22 to provide sound to the player.

The bill/ticket identification unit 28 may be housed in the cabinet 12 with the insertion opening exposed through which the bill/ticket is inserted. An identification part for identifying bill/ticket by various sensors is provided inside the insertion port. A bill/ticket storage part is provided on the output side of the identification part. The bill/ticket identification unit 28 accepts bill/tickets (including vouchers and coupons) that are the gaming value, identifies them as the gaming value, and notifies the control unit 22.

The printer unit 30 may be accommodated in the cabinet 12 in a state where a ticket output port through which the ticket is output is exposed. A printing part for printing predetermined information on a printing paper is provided inside the ticket output port, and a housing part for housing the printing paper is provided on the paper inlet side of the printing part. The printer unit 30, under control of the control unit 22, prints information on paper and outputs a ticket from the gaming machine 10 according to credit payout processing. The output ticket may be inserted into the bill/ticket identification unit 28 of another gaming machine to use the payout credit for game play, or may be exchanged for cash by a kiosk terminal inside of the casino or casino cage.

The operation unit 32 receives an operation of the player. The operation unit 32 includes a group of buttons for receiving various instructions from the player on the gaming machine 10. For example, the operation unit 32 may include a group of a spin button and setting buttons. The spin button receives an instruction to start an instance of a game (start rotation of reel). The group of setting buttons includes a group of bet buttons and the like, such as a cash-out button. The group of bet buttons receives an instruction operation related to a credit amount of a bet (bet amount) from a player. The cash-out button receives an instruction operation for instructing payout of credit accumulated in the gaming machine 10.

FIG. 2 is a block diagram illustrating an example of the configuration of a gaming machine. The gaming machine 10 includes the control unit 22. The control unit 22 includes a central processing unit (CPU) 38 that includes a processor constituting the control unit 22, an interface unit 40, a memory 42 (an example of a storage unit), a storage 44 (an example of a storage unit), and the like. The control unit 22 may be housed inside the cabinet 12 as a control board. The control unit 22 is configured to be able to communicate with each unit via the interface unit 40, and controls the operation of each unit by executing a program recorded in the memory 42 or the storage 44 of CPU 38 to provide a game to the player.

The interface unit 40 includes a chipset that provides communication functions for CPU 38, such as a memory bus connected to the CPU 38, various expansion buses, a serial interface, a universal serial bus (USB) interface, an Ethernet interface (registered trademark), and the like.

The memory 42 may include a random-access memory (RAM) that is a volatile storage medium, a read only memory (ROM) that is a nonvolatile storage medium, and an electrically erasable programmable read-only memory (EEPROM) that is a rewritable nonvolatile storage medium. The storage 44 provides the control unit 22 with a function as an external storage device, and can use a reader such as a memory card and a magneto-optical disk which are removable storage media, and can also use a hard disk.

The bill/ticket identification unit 28, the printer unit 30, a player tracking unit 20, a graphics controller (GPU: Graphics Processing Unit) 50, an input controller 52, a sound controller 53, and an illumination controller 54 are connected to the interface unit 40. The graphics controller 50, the input controller 52, the sound controller 53, and the illumination controller 54 may be housed inside cabinet 12 as control boards.

The control unit 22 is connected to the display 16 via the graphics controller 50. The control unit 22 is connected to the operation unit 32 via the input controller 52. The control unit 22 is connected to the illumination 36 via the illumination controller 54.

The control unit 22 controls each unit by executing programs stored in the memory 42 and the storage 44, and provides the game to the player. Here, for example, the program and data of the operating system and subsystem providing basic functions of the control unit 22 may be stored in the EEPROM of the memory 42, and the program and data of the application providing the game may be stored in the storage 44. According to such a configuration, the game can be easily changed or updated by exchanging the storage 44. Furthermore, the control unit 22 may have a multiprocessor configuration including a plurality of CPUs.

Hereinafter, each block connected to the control unit 22 will be described. The bill/ticket identification unit 28 accepts the bill/ticket at the insertion port and notifies the control unit 22 of identification information corresponding to the type of bills or payout processing of credit. The control unit 22 increases the credit amount usable in the game according to the notified contents. The printer unit 30 prints information corresponding to payout processing of credit from the gaming machine 10 on a ticket and outputs it under the control of the control unit 22 which receives the operation of a cash-out button included in the operation unit 32.

The player tracking unit 20 cooperates with the control unit 22 to transmit and receive player information and the like to and from the casino management system. The graphics controller 50 controls the display 16 under control of the control unit 22 to display a display image including various graphics data. The sound controller 53 drives the speakers 26 under the control of the control unit 22 to provide various sounds such as announcements, sound effects, BGM and the like. The illumination controller 54 performs lighting control of the illumination 36 under the control of the control unit 22.

The interface unit 40 includes various communication interfaces for communicating with the outside of the gaming machine 10. The interface unit 40 may communicate with external networks by Ethernet 58, 60 and a serial interface 62, as examples. FIG. 2 shows an example of communication with other gaming machines 10, a known server-side gaming network (Server-Based gaming), a G2S network (Game to System), and a slot information system (Slot Data System).

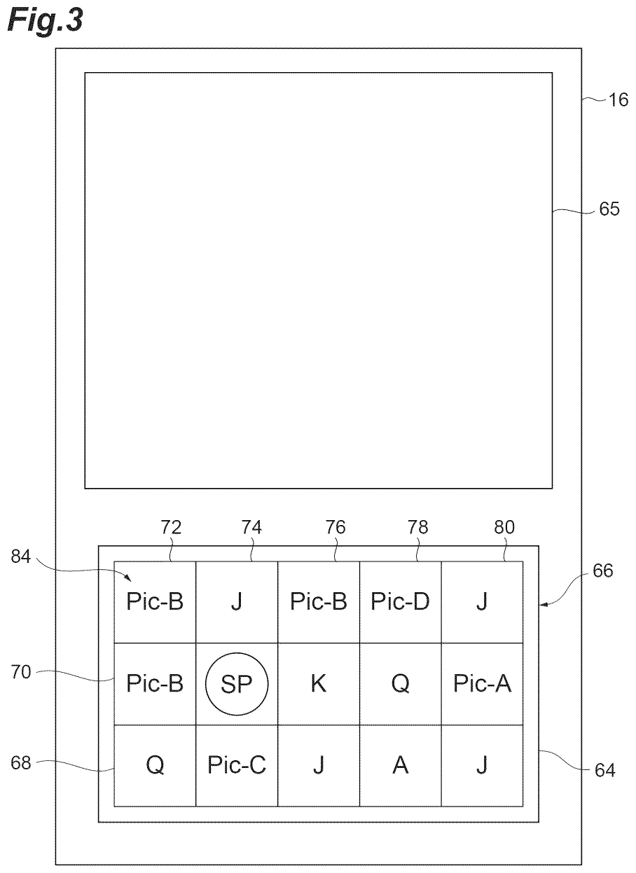

FIG. 3 is a schematic diagram of a display area of the gaming machine of FIG. 1. As shown in FIG. 3, a game screen is displayed in the display region of the display 16 by the control unit 22 executing a predetermined program. The game screen includes a symbol display region 64 for displaying a slot game. The symbol display region 64 is displayed in the lower region of the game screen as an example. Above the symbol display region 64, a region 65 is provided for displaying information related to the game and the like.

The symbol display region 64 includes a grid 68 capable of displaying symbols. By using such a display region, the gaming machine 10 operates as a slot machine that performs a winning determination according to a combination of symbols displayed on the grid 68 in the symbol display region 64 and provides a payout.

The display 16 displays a plurality of symbols in the grid 68. The grid 68 includes a plurality of rows and columns. The grid 68 is constituted by a plurality of cells 70 which are stop positions of symbols. FIG. 3 illustrates a game screen including a plurality of cells arranged in a 5×3 grid (matrix) pattern. The number of columns and the number of rows of the grid are not particularly limited, and may be another configuration such as 5×4, 3-4-4-4-3, 6×3, 6×4, or 3-3-3-5-5, or may be a configuration that increases or decreases according to the game progress and/or the bet amount. One symbol is stopped and displayed on each of a plurality of the cells 70 in the symbol display region 64.

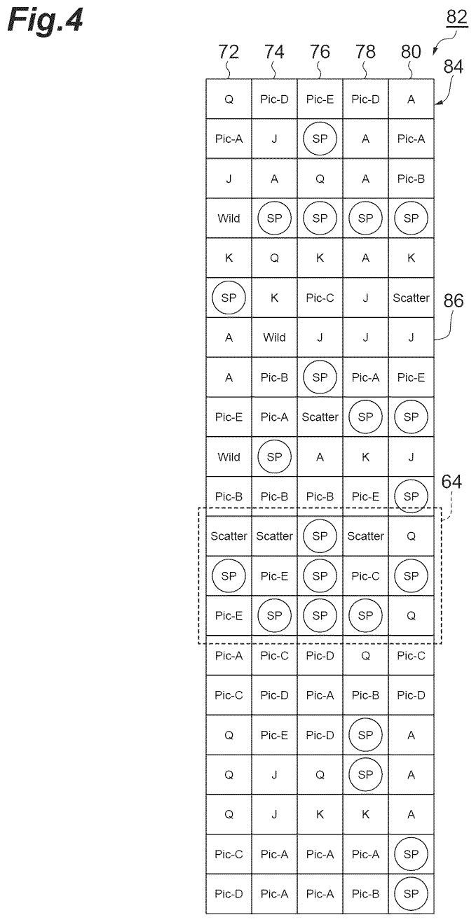

A symbol arranged in each of the plurality of cells 70 is determined by using a virtual reel strip for displaying a virtual reel 66. Hereinafter, the virtual reel 66 is also simply referred to as a reel. FIG. 4 is a diagram illustrating an example of a virtual reel set in a normal game. The virtual reel set includes a plurality of virtual reel strips, and the virtual reel strip includes symbol arrangements indicating the order of symbols displayed in the symbol display region 64. On each cell 70 of the grid 68 shown in FIG. 3, symbols are displayed based on symbol arrangements of the virtual reel 66 including virtual reel strips 72, 74, 76, 78, and 80 which form a virtual reel set 82. That is, the cells 70 of the grid 68 correspond to the virtual reel strips 72 to 80 by column, and the symbols arranged in predetermined parts of each virtual reel strip 72 to 80 are displayed. Furthermore, by moving (scrolling or spinning) each symbol by column based on the symbol arrangement of the virtual reel strips 72 to 80, the symbols displayed in the cells 70 of the grid 68 change, and by stopping the movement (scrolling or spinning) by columns, the symbols are stopped. Here, the virtual reel strips 72 to 80 are data, and the control unit 22 uses a program included in the memory 42 or the storage 44, and data showing the symbol arrangement (i.e., the order of symbols on each reel strip) regulated by each cell column. The virtual reel set 82 is a general term for such virtual reel strips 72 to 80.

The virtual reel strips 72 to 80 illustrated in FIG. 4 are constituted by symbols 84 in the respective symbol position 86, and these symbols are arranged in an order defined for each reel. The number of symbols forming the virtual reel strips 72 to 80 is not limited thereto, and may be a desired number. The number of symbols forming the virtual reel strips 72 to 80 may be the same or may be different from each other.

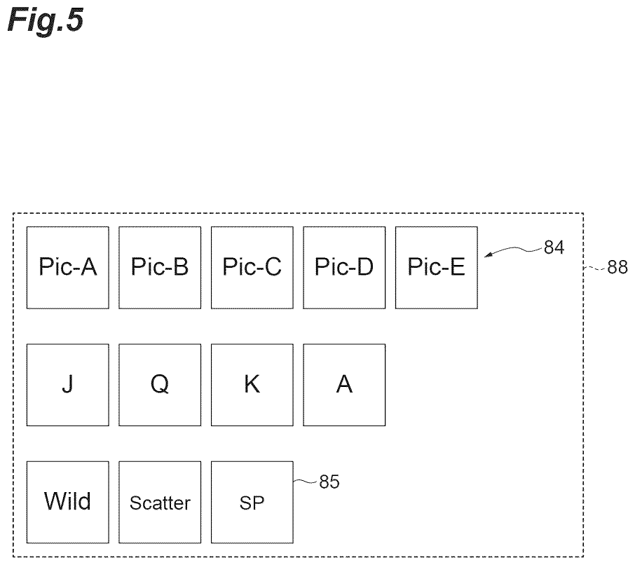

FIG. 5 is a detail of the symbols 84 shown in FIG. 4. Each of the virtual reel strips 72 to 80 includes symbols selected from a symbol set 88 of various symbols 84 shown in FIG. 5. The symbol set 88 includes card symbol (“J”, “Q”, “K”, and “A”) imitating playing cards as regular symbol, and picture symbol (“Pic-A”, “Pic-B”, “Pic-C”, “Pic-D”, and “Pic-E”) indicating a person, animal/plant, object, treasure, or wealth.

The symbol set 88 includes a special symbol 85 (“SP”). The special symbol 85 is a symbol associated with an award amount. As an example, the special symbol 85 is a credit symbol associated with a predetermined credit amount as an award. The credit symbol can maintain or enhance the player's interest by prompting the player to directly understand the credits that can be acquired and to directly understand the opportunity by the appearance of a credit symbol with a high credit amount. The credit symbol can be, for example, a predetermined picture symbol such as a coin on which the credit amount to be awarded is displayed. The special symbol 85 may be a jackpot symbol associated with a jackpot tier (rank) instead of a credit amount. The jackpot tier is a level corresponding to the amount of the winning award, such as MINI, MAJOR, MAXI, MEGA, GRAND, and the like. For example, MINI is converted to the credit amount of “100”, MAJOR to “500”, MAXI to “1000”, MEGA to “5000”, and GRAND to “10000”. The jackpot symbol can be, for example, a predetermined picture symbol such as a coin on which the jackpot tier to be awarded is displayed.

The symbol set 88 may include a wild symbol (“Wild”) that is substituted as another symbol when a winning combination is determined, and a scatter symbol (“Scatter”) that triggers a special game in response to the appearance of a predetermined number of symbols when a winning combination is determined.

A plurality of virtual reel sets may be prepared according to the game content. For example, the virtual reel set used in the normal game and the virtual reel set used in the special game may be the same or different. The virtual reel set in the special game may include more picture symbols, wild symbols, or special symbols 85 than the virtual reel set in the normal game. In this way, it is possible to increase the winning probability or expected value during the special game, and it is possible to provide the player with a valuable special game.

A payline is set in the symbol display region 64. The payline is set, for example, to extend from a cell in the leftmost column to the rightmost column. An example of a payline can be composed of any cell in the leftmost column, any cell in the second column from the left, any cell in the third column from the left, any cell in the fourth column from the left, and any cell in the fifth column from the left (the rightmost column). In a 5×3 matrix, 243 types (3 to the power of 5) of paylines can be set, but 40 or 50 types of these paylines may be set. In the so-called ALL-WAYS-WIN system, all 243 types of paylines are set as targets for winning determination. Such a payline may be configured to be activated as a win line by being selected by the player. A win line is a payline that is a target for winning determination. The number of win lines can be configured to be selectable by operating a group of line setting buttons included in the group of setting buttons of the operation unit 32 for the player. Also, a configuration may be adopted in which all the set paylines are made win lines regardless of the player's selection.

The gaming machine 10 of the present embodiment provides three types of games: a normal game (also referred to as a main game or base game) provided when a predetermined condition is not satisfied, and a special game and a feature game provided when a predetermined condition is satisfied. The special game is a free game and is provided without consuming game value. The free game is provided a predetermined number of times when a predetermined trigger condition is satisfied. The feature game is, for example, a respin game described later.

In the above-described normal game, special game, and feature game, a combination of symbols displayed in the symbol display region 64 among the symbol arrangement as a game result is subject to win determination. The control unit 22 starts the game and randomly determines the stopping position of each of the virtual reel strips 72 to 80. The virtual reel strips 72 to 80 displayed on the display 16 move (scroll or spin) from the current position and stop based on the stopping position to represent the game result. Therefore, in the display 16 or the grid 68, the symbols included in the virtual reel strips 72 to 80 change in accordance with continuous movement (scrolling or spinning) of the virtual reel strips 72 to 80 in the vertical direction of the symbol display region 64, and are displayed such that one symbol stops in one cell 70 according to the order of the symbols defined in the virtual reel strips 72 to 80.

The control unit 22 may be configured to change a plurality of symbols displayed on the display 16 by the above-described method in accordance with the operation of the player received by the operation unit 32, stop the symbols in a predetermined order, and provide a payout in accordance with the combination of symbols stopped in the symbol display region 64.

Furthermore, the control unit 22 provides a feature game when a predetermined trigger condition is satisfied in the normal game or the special game. In the feature game, a once-stopped reel is respun to provide a new combination of symbols. Such a feature game is also called a respin game. The trigger condition can be set as desired. The trigger condition may be satisfied, for example, when the special symbols 85 form a series of adjacent symbols on a win line in the symbol combination as a game result of the normal game or the special game. In the all-ways-win system, a series of adjacent symbols is formed when at least two adjacent reels stop the special symbol 85. The trigger condition may be satisfied when the first reel, which is the leftmost virtual reel strip 72, and the second reel, which is the virtual reel strip 74 adjacent to the first reel, stop the special symbol 85. The trigger condition may be satisfied based on another random number, regardless of the game result.

If the trigger condition is satisfied, the control unit 22 determines a reel to be respun. If the trigger condition is satisfied when the first reel and the second reel stop the special symbol 85, the control unit 22 determines the reels that do not form a series of adjacent symbols as the reels to be respun. In this case, the virtual reel strip 76, which is the third reel, the virtual reel strip 78, which is the fourth reel, and the virtual reel strip 80, which is the fifth reel, become the reels to be respun.

If a special symbol 85 is stopped in the symbol display region 64 by a reel to be respun, that is, if the reel to be respun is already displaying the special symbol 85, the control unit 22 miniaturizes the special symbol 85 and holds it in the cell where it stopped, so that another symbol can be stopped in that cell. The miniaturization of the special symbol 85 is, for example, to reduce the size of the special symbol 85 while maintaining its appearance. The miniaturization of the special symbol 85 may be to display it in the cell in a manner that the award amount associated with the special symbol 85 is visible. The miniaturization is performed to an extent that it is visible that another symbol has stopped in the cell. Holding in a cell means that it is fixedly displayed in that cell regardless of the spinning of the reels. That is, the miniaturized special symbol remains in the cell where it first stopped without moving even if the reel is respun. In this way, the control unit 22 holds the reels that form a series of adjacent symbols, miniaturizes the special symbol 85 that satisfies the condition, and then respins and stops the unheld reels.

The control unit 22 may determine a reel to be respun again if a predetermined trigger condition is satisfied after the respin. For example, if a new special symbol 85 connects to a series of adjacent symbols when the respun reel stops, that is, if a new special symbol 85 stops at a position that connects to a series of adjacent symbols, the control unit 22 further holds the reel corresponding to the new special symbol 85 and respins the unheld reels. Connection means being adjacent in the arrangement of symbols on a win line. For example, if the first reel and the second reel are held reels, and the third reel stops the special symbol 85 when the third, fourth, and fifth reels are respun and stopped, the special symbol 85 of the third reel will connect to the series of adjacent symbols formed by the special symbols 85 of the first and second reels. In this case, the control unit 22 sets the third reel as a new held reel and determines the fourth and fifth reels as the reels to be respun. Note that a plurality of special symbols 85 may connect to the series of adjacent symbols at once. Since the control unit 22 can hold the reels that contribute to a win or the reels that already constitute a win, it can avoid a situation where the symbols that have already formed a win are lost due to a respin, thereby preventing a disadvantage to the player.

If a predetermined trigger condition is not satisfied after the respin, the control unit 22 ends the respin game. For example, if a new special symbol 85 does not connect to the series of adjacent symbols when the respun reel stops, the control unit 22 does not execute the next respin. If a series of adjacent symbols is formed by all the reels, the control unit 22 ends the respin game because there are no reels to be respun.

The control unit 22 determines a win based on the finally formed new combination of symbols. At this time, the control unit 22 can add the award amount of the miniaturized special symbol. That is, the control unit 22 may be configured to determine an award based on the symbols on the win line and the miniaturized special symbol on the win line, and provide the determined award to the player.

In the feature game, the control unit 22 may apply a different winning determination method from the normal game or the special game. For example, the control unit 22 provides to the player the award amount associated with the special symbols 85 that formed a series of adjacent symbols on the win line. The control unit 22 may provide to the player the award amount associated with the special symbol 85 that formed a series of adjacent symbols when a series of adjacent symbols composed of a predetermined number or more of special symbols 85 is formed. For example, the control unit 22 may not determine a win in the case of a series of adjacent symbols composed of the special symbols 85 of the first and second reels, but may determine a win in the case of a series of adjacent symbols composed of the special symbols 85 of the first, second, and third reels. Such a winning determination method has a high affinity with the respin game, and it can be configured such that an award is provided in response to the special symbol 85 stopping on the third reel by the first respin in the respin game provided by the special symbol 85 being adjacent on the first and second reels. Also, just by selecting a reel to be respun, an opportunity to win or an opportunity to increase the award at the time of winning can be provided.

The control unit 22 can provide the award amount of the miniaturized special symbol to the player. That is, the control unit 22 may be configured to provide to the player a sum of the award amount associated with the special symbol 85 that formed a series of adjacent symbols on the win line, and the award amount of the miniaturized special symbol that appeared in the same cell as the special symbol. In this way, the control unit 22 can stop two or more symbols in one cell and use two or more symbols for the award. Since not only the award amount associated with the special symbol 85 that formed a series of adjacent symbols but also the award amount of the miniaturized special symbol is provided to the player, the upper limit of the award that can be obtained at one time can be increased.

When providing the total award amount associated with the special symbol 85 and the miniaturized special symbol to the player, the control unit 22 may display a frame in the symbol display region 64 to distinguish between the special symbol 85 that is awarded as an award at the time of winning and the special symbol 85 that is not awarded as an award at the time of winning. For example, when performing a respin, the control unit 22 displays a frame enclosing a first display region corresponding to the held reels and a second display region corresponding to reels adjacent to the held reels. For example, if the first reel and the second reel are held reels, and the third, fourth, and fifth reels are unheld reels, the control unit 22 displays one frame enclosing the first display region corresponding to the first and second reels and the second display region corresponding to the third reel, which is an adjacent reel. Then, it starts the respin of the third, fourth, and fifth reels. By paying attention to the frame, the player can understand at a glance that at the time of winning, only the special symbol 85 stopped by the first, second, and third reels contributes to the award, and the special symbol 85 stopped on the fourth and fifth reels does not contribute to the award.

When a new special symbol 85 is stopped by the adjacent reel, the control unit 22 expands the frame to include a third display region corresponding to a reel further adjacent to the adjacent reel that stopped the special symbol 85. For example, if the adjacent reel is the third reel, when the special symbol 85 is stopped by the third reel, the control unit 22 expands the frame before the fourth reel stops, so as to include the third display region corresponding to the fourth reel, which is a reel further adjacent to the third reel. In this way, the frame is expanded each time the number of reels forming a series of adjacent symbols increases. When the respin ends, the control unit 22 provides to the player the total of the award amounts associated with the special symbol 85 and the miniaturized special symbol stopped within the range enclosed by the frame. By using the frame, the control unit 22 allows the player to play the game without being conscious of the win line.

Hereinafter, an example will be described in which a feature game is triggered in a normal game or a free game, and an all-ways-win type respin game is provided. It is assumed that the trigger condition for the feature game is satisfied, for example, when the special symbol 85 is displayed by the first and second reels. Also, an example will be described in which the special symbol 85 is a credit symbol, and a win is determined when a series of adjacent symbols is formed by the first, second, and third reels.

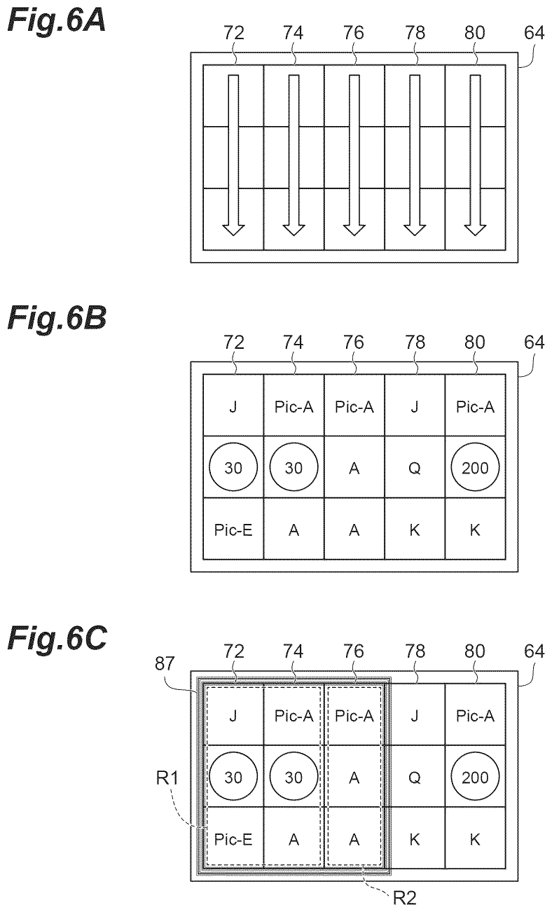

As shown in FIG. 6A, the control unit 22 spins the reels corresponding to the virtual reel strips 72 to 80 and stops them sequentially. As a result, the symbol combination shown in FIG. 6B is displayed as the game result. In the displayed symbol combination, since a credit symbol with a credit amount of “30” is displayed by the first and second reels, a series of adjacent symbols is formed, and the feature game is triggered.

When the control unit 22 starts the feature game, as shown in FIG. 6C, it displays a frame 87 enclosing a first display region R1 corresponding to the first and second reels and a second display region R2 corresponding to the adjacent third reel. At the end of the respin game, the award amount associated with the credit symbol displayed within the frame 87 is awarded. Therefore, although the credit amount “30” associated with the credit symbols on the first and second reels is acquired upon winning, the credit amount “200” associated with the credit symbol on the fifth reel is not acquired at this point even if a win occurs. However, in this respin game, the once-displayed credit symbol is miniaturized and held to give it a chance to be acquired.

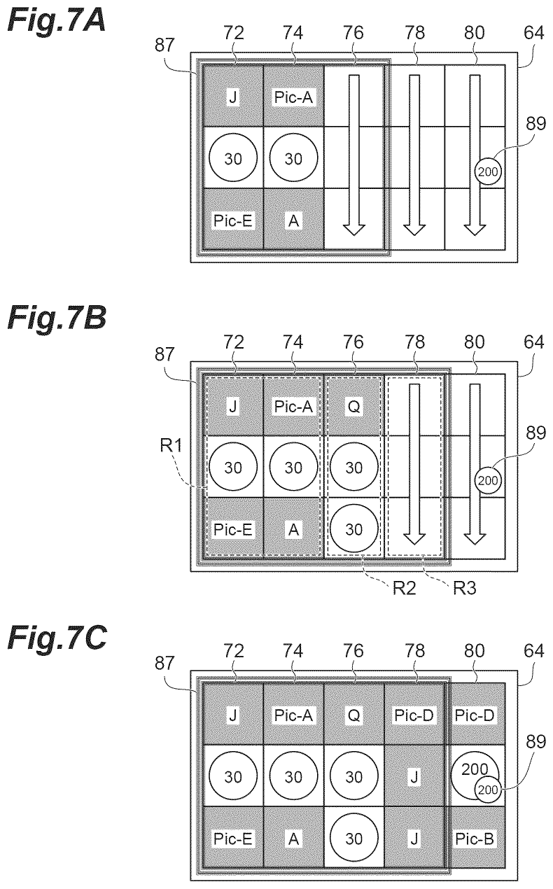

As shown in FIG. 7A, the control unit 22 holds a miniaturized symbol 89, which is a miniaturized version of the credit symbol displayed on the fifth reel, in the cell where the credit symbol was displayed. The miniaturized symbol 89 has a size that allows another symbol to be displayed in the cell. This prevents the once-displayed credit symbol from being moved and lost by a respin and being excluded from the award, thereby suppressing the player's disappointment. Then, the control unit 22 executes a respin of the unheld reels, which are the third, fourth, and fifth reels. At this time, on the held reels, which are the first and second reels, symbols other than the credit symbol do not contribute to the award and are grayed out. Also, on the reels to be respun, symbols other than the credit symbol are grayed out.

As shown in FIG. 7B, the third reel stops first. It is assumed that a credit symbol with a credit amount of “30” is stopped by the third reel. In this case, the credit symbol stopped by the third reel is connected to the adjacent symbols formed by the first and second reels. The control unit 22 expands the frame 87 before the fourth reel stops, so as to include a third display region R3 corresponding to the fourth reel, which is a reel further adjacent to the third reel.

As shown in FIG. 7C, it is assumed that the fourth reel stops and no credit symbol stops. In this case, since no new credit symbol is connected to the adjacent symbols, the frame 87 is not expanded. Also, although the fifth reel stops and a credit symbol is displayed, since the credit symbol is outside the frame 87, the credit amount “200” associated with the credit symbol on the fifth reel is not acquired at this point even if a win occurs. Since a new credit symbol was connected to the adjacent symbols by the third reel, the control unit 22 executes a further respin.

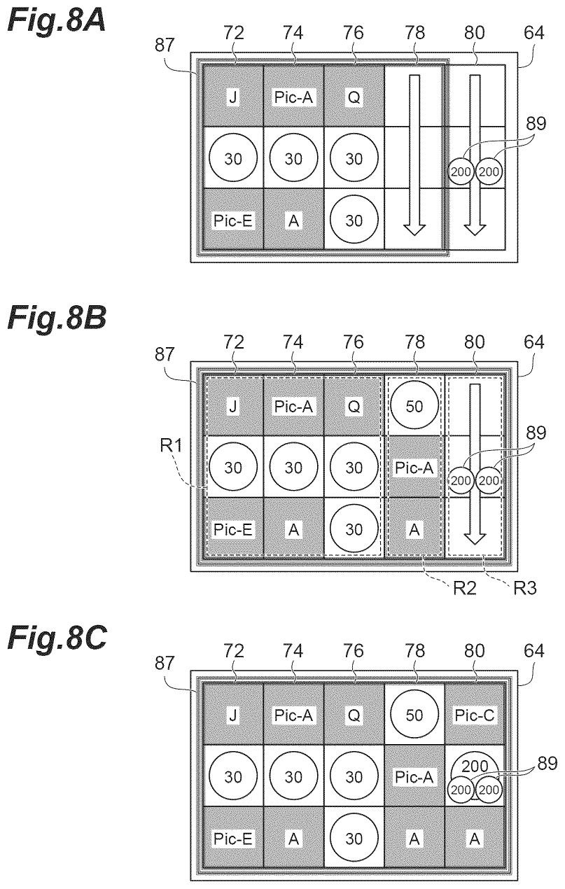

As shown in FIG. 8A, the control unit 22 further holds a miniaturized symbol 89, which is a miniaturized version of the credit symbol displayed on the fifth reel, in the cell where the credit symbol was displayed. There are two miniaturized symbols 89 with credit amounts of “200” and “200”. Then, the control unit 22 executes a respin of the unheld reels, which are the fourth and fifth reels.

As shown in FIG. 8B, the fourth reel stops first. It is assumed that a credit symbol with a credit amount of “50” is stopped by the fourth reel. In this case, the credit symbol stopped by the fourth reel is connected to the adjacent symbols formed by the first, second, and third reels. The control unit 22 expands the frame 87 before the fifth reel stops, so as to include a third display region R3 corresponding to the fifth reel, which is a reel further adjacent to the fourth reel.

As shown in FIG. 8C, it is assumed that the fifth reel stops and a credit symbol with a credit amount of “200” stops. In this case, since the frame 87 is at its maximum size, it is not expanded. Also, since no new credit symbol connects to the adjacent symbols, the respin game ends. Then, the control unit 22 provides to the player a credit amount of “770”, which is the sum of the award amounts “30”, “30”, “30”, “30”, “50”, and “200” associated with the credit symbols displayed within the frame 87, and the award amounts “200” and “200” associated with the miniaturized symbols 89.

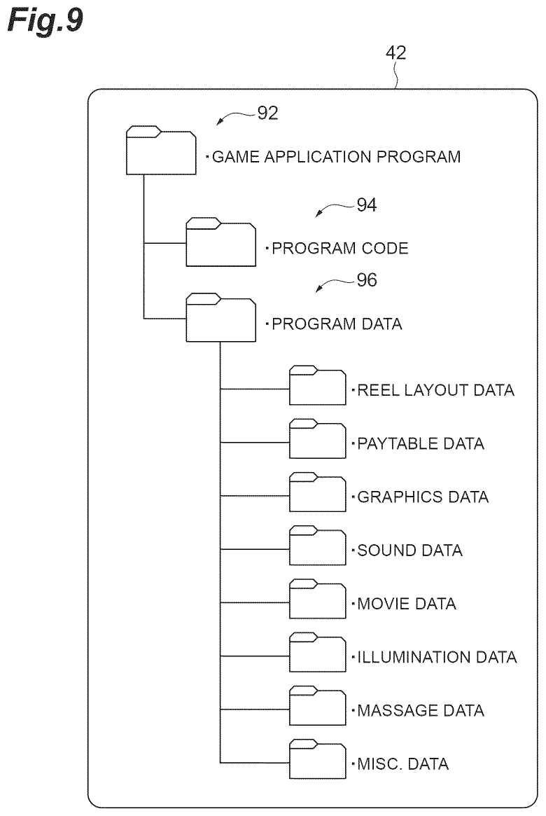

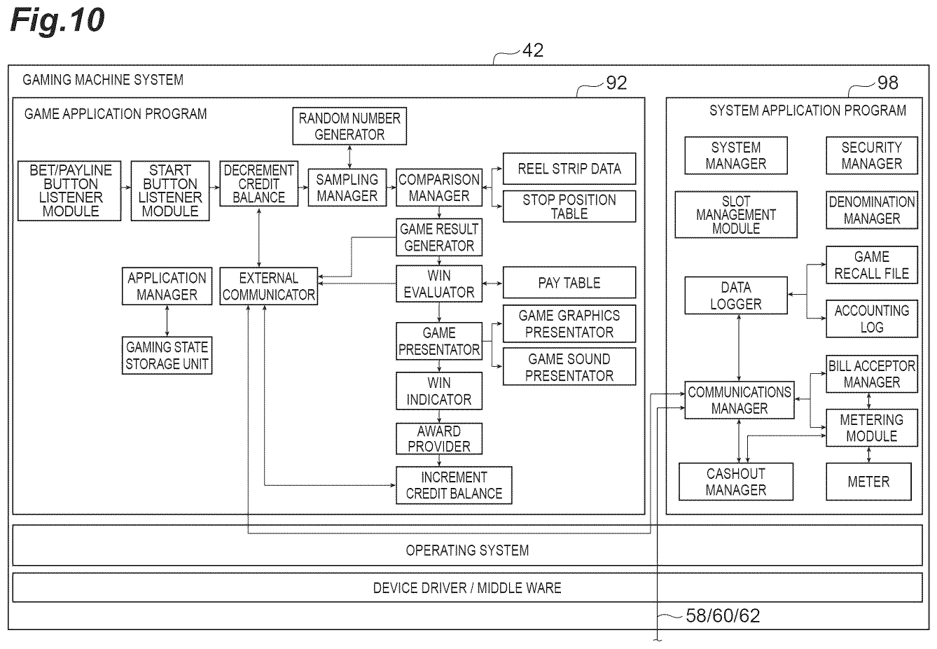

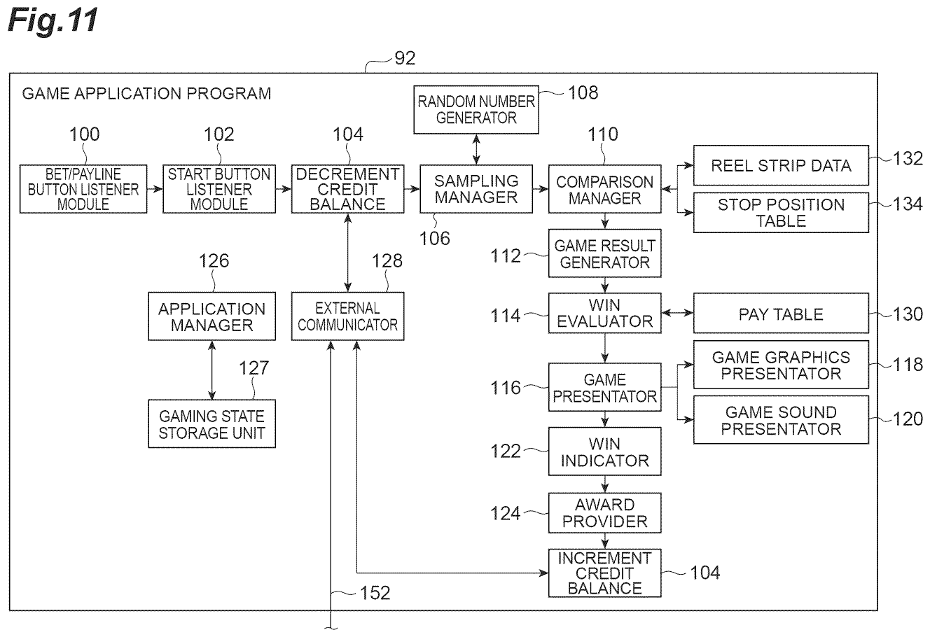

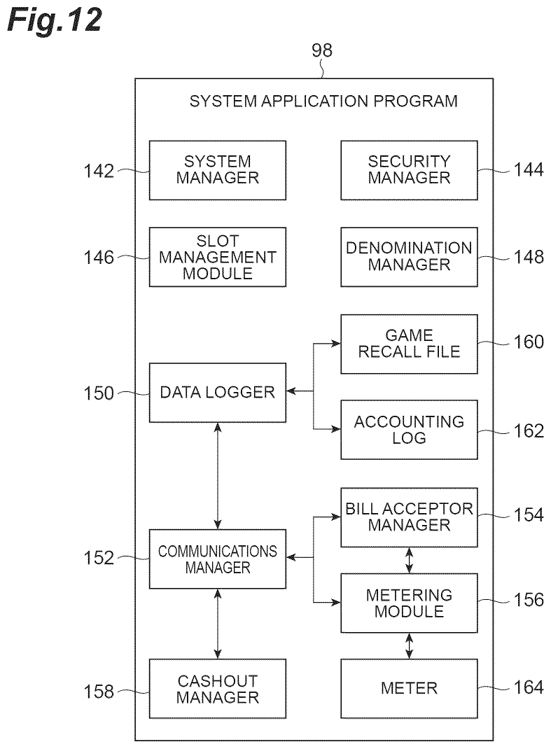

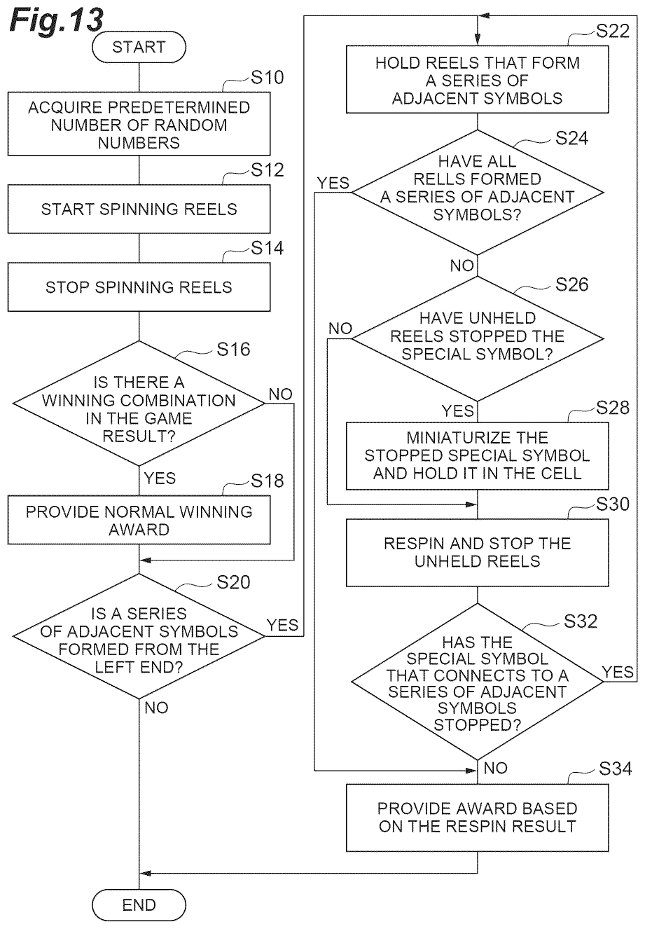

FIGS. 9 and 10 are a directory configuration diagram and a block diagram showing programs and data stored in the memory of FIG. 2. FIG. 11 is a block diagram of the game application program of FIG. 10. FIG. 12 is a block diagram of the system application program shown in FIG. 10. In the embodiments shown in FIGS. 9 to 12, the memory 42 stores a game application program 92 including computer-executable instructions, and processing of the game is performed by executing these computer-executable instructions in the CPU 38, and the game screen is displayed on the display 16 in the gaming machine 10. Also, in one embodiment, the game application program 92 includes program code 94 and program object data 96 that include computer-executable instructions for implementing a game using the algorithm shown in FIG. 13.

In an exemplary embodiment, the memory 42 stores a game application program 92 and a system application program 98 including computer-executable instructions that are executed in the CPU 38 to process the game and display a game screen on the display 16 of the gaming machine 10. The game application program 92 provides a game-specific front-end function by executing on the CPU, and the system application program 98 provides a generic back-end function. In the illustrated embodiment, the game application program 92 and the system application program 98 are implemented on the same operating system. However, it should be noted that these programs may be implemented on respective operating systems and/or by respective processors.

In one embodiment, the game application program 92 includes a plurality of software modules including a bet/payline button listener module 100, a start button listener module 102, a credit balance manager module 104, a sampling manager 106, a random number generator (RNG) 108, a comparison manager 110, a game result generator 112, a win evaluator 114, a game presentator 116, a game graphics presentator 118, a game sound presentator 120, a win indicator 122, an award provider 124, an application manager 126, and an external communicator 128. The game application program 92 may also include a pay table 130, reel strip data 132, and a stop position table 134.

The bet/payline button listener module 100 is a software module for receiving a signal from a bet button of the operation unit 32, the signal being generated by the button when the player operates the button to select a bet amount. In response to receiving the signal, the bet/payline button listener module 100 communicates the occurrence of the signal to the application manager 126 for changing the bet of the game.

The start button listener module 102 is a software module for receiving a signal from a start button, which is generated when the player operates the button to start a game. In response to receiving the signal, the start button listener module 102 communicates the occurrence of the signal to the application manager 126 to initiate the game.

In response to receiving a signal from the start button listener module 102, the application manager 126 requests the sampling manager 106 to obtain the required number of random numbers from the random number generator 108.

The random number generator 108 is a software module for generating random numbers based on a predetermined algorithm of computational random generation method. The random number generator 108 may be a pseudorandom number generator. The random number generator 108 returns the random numbers in response to a request from the sampling manager 106. The random number generator 108 may be implemented in part or in whole as an integrated circuit or wired logic.

The comparison manager 110 compares the current state of the game and/or each random number with the reel strip data 132 and the stop position table 134, and specifies the stopping position of the corresponding reel strip based on each random number.

The reel strip data 132 has virtual reel strips for normal games, free games, and special games. The comparison manager 110 described above queries the application manager 126 to identify the current state of the game and selects virtual reel strips.

The stop position table 134 includes a range of random numbers associated with each stopping position of the virtual reel strip. The comparison manager 110 determines the stopping position of each reel based on the corresponding random number and the stop position table 134.

The game result generator 112 generates a game result based on the selected reel layout, the stopping position of each reel, the stopping position of the inner symbol, and the attribute to be added. In one embodiment, the game result generator 112 may apply a change on the game result when a predetermined condition is satisfied.

The win evaluator 114 evaluates the game result with reference to the pay table 130. To be specific, the winning evaluation is performed based on whether symbols defined as a winning combination in the pay table 130 stop.

The game presentator 116 utilizes the game graphics presentator 118 and the game sound presentator 120 to provide a game presentation process consisting of video animation and sound to eventually form a predetermined game result.

The game sound presentator 120 provides a sound presentation process by using the sound controller 53 and speakers 26. The win indicator 122 indicates a winning combination and a payment condition of prize symbol formed in the game result. The award provider 124 provides award credit to the win meter based on the win evaluation.

The application manager 126 administrates the operation and state of each software module. In addition, the application manager 126 administrates the configuration, progress, and states of the game application program 92. The application manager 126 refers to a gaming state storage unit 127, determines the size of the symbol display region 64 based on the stored game state, and provides the game. The external communicator 128 communicates instructions and data with the system application program 98.

The credit balance manager module 104 executes a process for decrementing the credit balance according to the bet amount and incrementing the credit balance based on the total amount of winnings displayed on the winning meter. The pay table 130 includes a payout amount or award amount associated with each winning combination.

In an exemplary embodiment, the system application program 98 provides background processing and functions other than game-specific functions. The system application program 98 includes a plurality of software modules including a system manager 142, a security manager 144, a slot management module 146, a denomination manager 148, a data logger 150, a communications manager 152, a bill acceptor manager 154, a metering module 156, and a cashout manager 158.

The system application program 98 may include a game recall file 160, an accounting log 162, and a meter 164. The system manager 142 is a software module for administrating all of the background processing and functions other than game-specific functions conducted by the system application program 98.

The security manager 144 is a software module for administrating game verification, door security, and monitoring security sensors. The slot management module 146 is a software module for administrating data accumulation and communicating with an external slot information system.

The denomination manager 148 is a software module for establishing the denomination setting of the gaming machine 10. The denomination setting may include 1 cent, 2 cents, 5 cents, 25 cents, 1 dollar, 5 dollars, and the like. The data logger 150 is a software module for logging the results of each game in a game recall. In addition, the data logger 150 stores error events, bill logs, cashout logs, ticket logs, and the like in an accounting log.

The game recall file 160 is accumulated data including the results of each game. The game recall file 160 is stored in non-volatile memory. The accounting log 162 is accumulated data including error events, bill logs, cashout logs, ticket logs, and the like. The accounting log 162 is stored in non-volatile memory.

The communications manager 152 is a software module for administrating communication between the game application program 92 and the system application program 98. The communications manager 152 also administrates network communications between the system application program 98 and other gaming machines 10, external network such as slot management system network, G2S network, gaming server for server-based gaming network or VLT system network.

The bill acceptor manager 154 is a software module for managing bill acceptors, and accepts bill information inserted in the bill acceptor. In response to receiving the information from the bill acceptor, the bill acceptor manager 154 communicates with the metering module to increment the credit balance based on the inserted bill.

The metering module 156 is a software module for adjusting the value of the meter 164 in response to communication with the game application program 92 via the communications manager 152, the bill acceptor manager 154, or the cashout manager 158. The meter 164 includes a credit meter to indicate the current credit balance of the gaming machine and a win meter to indicate the total amount of wins for the current gaming session. The meter further includes background meters, such as coin-in, coin-out, total drop, attendant paid jackpot, and/or bill-in. These meters may be implemented as data on non-volatile memory or hardware meters.

The cashout manager 158 is a software module for administrating a cashout procedure. In response to the player's operation on the cashout button, the cashout manager 158 is activated and the gaming machine pays the total amount of credit meters in cash or a voucher.

FIG. 13 is a flowchart for explaining the operation of the gaming machine. The algorithm (gaming method) of the operation of the gaming machine is implemented in the game application program 92 and is embodied by the CPU 38 executing the game application program 92. The operation of the gaming machine includes a plurality of steps. Each step may be performed independently or may be performed in combination with other steps.

In step S10, the control unit 22 receives a game start operation by the player, and upon receiving an operation of the spin button from the player, subtracts the set total bet amount from credit and acquires a predetermined number of random numbers required to provide the game. Random numbers are generated internally in the random number generator 108 of the control unit 22. The control unit 22 may acquire random numbers from a random number generator provided separately from the control unit 22, or may acquire random numbers from devices such as servers provided outside the gaming machine 10.

In step S12, the control unit 22 starts spinning a plurality of reels. Next, in step S14, the control unit 22 stops spinning the plurality of reels. In step S16, the control unit 22 determines the symbol combination as the game result and determines whether the symbol combination has a winning combination. If it is determined that there is a win (step S16: YES), in step S18, the control unit 22 provides an amount corresponding to the win as an award (normal win). For example, the control unit 22 adds the amount corresponding to the win to the held credit. If it is determined that there is no win (step S16: NO), no award is provided.

Subsequently, in step S20, the control unit 22 determines whether a feature game has been triggered. The control unit 22 determines that a feature game has been triggered if a series of adjacent symbols is formed from the left end. As a specific example, the control unit 22 determines that a feature game has been triggered if the special symbol 85 is stopped on at least the first and second reels.

If it is determined that a feature game has been triggered (step S20: YES), in step S22, the control unit 22 holds the reels that form a series of adjacent symbols. Subsequently, in step S24, the control unit 22 determines whether all reels form a series of adjacent symbols. This is to determine whether there are any reels to be respun.

If it is determined that not all reels are held (step S24: NO), in step S26, the control unit 22 determines whether any unheld reel has stopped the special symbol 85. First, the control unit 22 determines the reels other than the held reels as the reels to be respun (unheld reels). Then, the control unit 22 determines for each unheld reel whether the special symbol 85 is stopped. If it is determined that an unheld reel has stopped the special symbol 85 (step S26: YES), in step S28, the control unit 22 miniaturizes the stopped special symbol 85 and holds it in the cell (see FIG. 7A or FIG. 8A).

If it is determined that the unheld reels have not stopped the special symbol 85 (step S26: NO), or if step S28 has ended, the control unit 22 respins and stops the unheld reels in step S30. Subsequently, in step S32, the control unit 22 determines whether a special symbol 85 that connects to a series of adjacent symbols has stopped.

If it is determined that a special symbol 85 that connects to a series of adjacent symbols has stopped (step S32: YES), the process returns to step S22. As a result, steps S22 to S32 are repeatedly executed until it is determined that no special symbol 85 that connects to a series of adjacent symbols has stopped.

If it is determined that all reels form a series of adjacent symbols (step S24: YES), or if it is determined that no special symbol 85 that connects to the series of adjacent symbols has stopped (step S32: NO), the control unit 22 provides an award based on the respin result in step S34. For example, the control unit 22 provides to the player the total of the award amount associated with the credit symbol displayed within the frame 87 and the award amount associated with the miniaturized symbol 89.

When step S34 ends, or if it is determined that a feature game has not been triggered (step S20: NO), the flowchart shown in FIG. 13 ends.

As described above, in the gaming machine 10, a plurality of reels are spun and stopped to display symbols in the cells of the symbol display region 64. If the symbols in the symbol display region 64 satisfy a predetermined condition when the plurality of reels stop, one or more reels to be respun are determined. At this time, if a special symbol 85 is stopped in the symbol display region 64 by the reel to be respun, the special symbol 85 is miniaturized and held in the cell. This allows another symbol to stop in the cell where the special symbol 85 has stopped. Then, the reel to be respun is respun and stopped. Since another symbol stops in the cell where the special symbol 85 is held, two symbols, the special symbol 85 and the other symbol, will stop in one cell. Then, an award is determined based on the symbols on the win line and the award amount associated with the miniaturized special symbol on the win line, and the determined award is provided to the player. In this way, the gaming machine 10 can determine the award using the award amount associated with the miniaturized special symbol on the win line. Therefore, the gaming machine 10 can prevent a once-displayed special symbol 85 from being moved by a respin and excluded from the award, thereby suppressing a situation that fails to meet the player's expectations, and allow the player to expect a new win that occurs when another symbol stops while maintaining the special symbol 85. Therefore, the gaming machine 10 can provide a game that has new gameplay to attract the player's interest and is capable of offering a progression that sufficiently provides new stimulation and excitement to a player and the gaming machine 10 implements game mechanics that enable such gameplay.

The gaming machine 10 may be a client computing device, in which case a game is delivered from a network server computer system to one or more client computing devices via a communication network. The processor of the client computing device may be programmed to function as the control unit 22 of the gaming machine 10.

When the gaming machine 10 is used as a client computing device, (1) a rich client system may be used in which most of the processing involved in game execution is performed on the client side and results are transmitted to the server, (2) a thin-client system may be used in which only minimum processing is performed on the client side and main processing is performed on the server side, and (3) a zero client system may be used in which most of data storage and processing is performed on the server side and the client specializes in input and output. In this case, the software configuration described in the embodiment is distributed and implemented in the client and the server.

In the above-described embodiment, an example was described in which the special symbol 85 is miniaturized and held in the cell, but the special symbol 85 may be miniaturized and held in another position. For example, the miniaturized symbol 89 may be held at any position in the display region of the display 16. If all reels form adjacent symbols when the respin game is triggered, the control unit 22 may determine a predetermined reel or a randomly determined reel as a reel to be respun and provide a respin game as an extra respin game. The control unit 22 may expand the symbol display region 64 in the free game. Even in this case, the control unit 22 can provide a feature game by adopting the all-ways-win system.

The function of the control unit 22 of the gaming machine 10 described above can also be realized by a computer executing a program. That is, it is possible to create a program that causes one or more computers to function in the same manner as the control unit 22 described above. The program may be provided by being recorded in a computer-readable recording medium such as a ROM or a semiconductor memory. Such a program may be divided into a plurality of modules.

Additionally, various modifications can be made to the operation in each embodiment. For instance, a mode could be adopted where a necessary number of random numbers are acquired in advance to determine the reel stop positions. Once the winning of the special game and the determination of the presence or absence of winning are completed, the contents are sequentially displayed on the display. Moreover, for instance, the control unit 22 could collectively acquire a necessary number of random numbers at the start of the game. Each random number could then be stored in a storage area of the memory 42 or the storage 44, which is not erased even when there's a power source anomaly. In this scenario, even if a power failure or similar event occurs during the game, the control unit 22 can reproduce the game's progress. This is done by acquiring the random number, which was obtained at the start of the game before the power failure, from the memory 42 or the storage 44 when resuming the game after power restoration. For instance, if a power supply abnormality occurs just before the formation of a game result in which a high payout is obtained, a problem could arise if the same game doesn't proceed after power restoration. However, by collectively acquiring all random numbers at the start of the game and storing these numbers in the memory 42 or the storage 44 as described above, it's possible to reproduce the game's progress similar to that before the power source abnormality occurred, after power recovery. This way, such a problem can be avoided.

Additionally, in the described embodiment, a bill or a ticket represents the game value. The bill or ticket is received by the bill/ticket identification unit, and the ticket is output by the printer unit. However, the present disclosure is not limited to this setup. The game value concept includes tangible objects like coins, bills, medals, or tickets, as well as electronic data such as virtual credits or virtual currencies with equivalent value. For instance, a coin acceptor could accept coins and dispense coins from a coin hopper. One mode could involve identifying a player and using credits accumulated in a server account, with credits being paid out to the account. Alternatively, a mode could be adopted where credit information recorded on a storage medium like a magnetic card or an IC card is read and used, with credits being paid out by writing the information back to the storage medium. Furthermore, credits could be electronically transferred to and from a smartphone or a wearable device.

What is claimed is:

1. A gaming machine comprising:
a display unit having a display region for displaying a symbol in each of cells arranged in a matrix, the display region being provided with a win line composed of a plurality of cells, and symbols including a special symbol associated with a predetermined award amount; and
a control unit connected to the display unit, wherein the control unit is configured to:
spin and stop a plurality of reels to cause the symbols to be displayed in the display region;
determine a reel to be respun if the symbols in the display region satisfy a predetermined condition after the plurality of reels stop;
when the special symbol is stopped in the display region by the reel to be respun, miniaturize the special symbol and hold the miniaturized special symbol in a cell where the special symbol has stopped, to allow another symbol to be stopped in the cell;
respin and stop the reel to be respun;
determine an award based on an award amount associated with the special symbols and the miniaturized special symbols displayed on the win line; and
provide the determined award to a player.

2. The gaming machine according to claim 1, wherein the control unit determines the reel to be respun in response to the special symbol forming a series of adjacent symbols on the win line when the plurality of reels stop.

3. The gaming machine according to claim 2, wherein the control unit provides to the player a sum of the award amount associated with the special symbol that formed the series of adjacent symbols on the win line, and the award amount of the miniaturized special symbol that appeared in the same cell as the special symbol.

4. The gaming machine according to claim 2, wherein the control unit holds reels that form the series of adjacent symbols, and respins unheld reels.

5. The gaming machine according to claim 4, wherein the control unit is configured to:
when a respun reel stops, if a new special symbol connects to the series of adjacent symbols, further hold a reel corresponding to the new special symbol and respin the unheld reels; and
when a respun reel stops, if the new special symbol does not connect to the series of adjacent symbols, not execute a next respin.

6. The gaming machine according to claim 5, wherein the control unit is configured to:
display a frame enclosing a first display region corresponding to held reels and a second display region corresponding to an adjacent reel adjacent to the held reels, when performing a respin;
when a new special symbol is stopped by the adjacent reel, expand the frame to include a third display region corresponding to a reel further adjacent to the adjacent reel that stopped the new special symbol; and
provide to the player a total of award amounts associated with the special symbol and the miniaturized special symbol stopped within a range enclosed by the frame when the respin ends.

7. A game providing method executed in a gaming machine comprising a display unit having a display region for displaying a symbol in each of cells arranged in a matrix, the display region being provided with a win line composed of a plurality of cells, and symbols including a special symbol associated with a predetermined award amount, and a control unit connected to the display unit, the method comprising:
spinning and stopping a plurality of reels to cause the symbols to be displayed in the display region;
determining a reel to be respun if the symbols in the display region satisfy a predetermined condition after the plurality of reels stop;
when the special symbol is stopped in the display region by the reel to be respun, miniaturizing the special symbol and holding the miniaturized special symbol in a cell where the special symbol has stopped, to allow another symbol to be stopped in the cell;
respinning and stopping the reel to be respun;
determining an award based on an award amount associated with the special symbols and the miniaturized special symbols displayed on the win line; and
providing the determined award to a player.

8. A computer-readable storage medium storing a program executed by a control unit in a gaming machine comprising a display unit having a display region for displaying a symbol in each of cells arranged in a matrix, the display region being provided with a win line composed of a plurality of cells, and symbols including a special symbol associated with a predetermined award amount, and a control unit connected to the display unit, the program causing the control unit to:
spin and stop a plurality of reels to cause the symbols to be displayed in the display region;
determine a reel to be respun if the symbols in the display region satisfy a predetermined condition after the plurality of reels stop;
when the special symbol is stopped in the display region by the reel to be respun, miniaturize the special symbol and hold the miniaturized special symbol in a cell where the special symbol has stopped, to allow another symbol to be stopped in the cell;
respin and stop the reel to be respun;
determine an award based on an award amount associated with the special symbols and the miniaturized special symbols displayed on the win line; and
provide the determined award to a player.
